(19) United States
(12) Patent Application Publication
(10) Pub. No.: US 2008/0257277 A1
(43) Pub. Date: Oct. 23, 2008

(54) Exerciser for Humans and/or Animals

(76) Inventor: Leslie James Smith, Queensland (AU)

Correspondence Address: ECKERT SEAMANS CHERIN & MELLOTT, 600 GRANT STREET, 44TH FLOOR, PITTSBURGH, PA, 15219, US

(21) Appl. No.: 11/573,053

(22) PCT Filed: Aug. 5, 2005
(86) PCT No.: PCT/AU2005/001175

§ 371 Date: Feb. 6, 2008

(30) Foreign Application Priority Data
Aug. 5, 2004 (AU) 2004904387

(51) Int. Cl. A01K 15/02

(52) U.S. Cl. 119/704

(57) ABSTRACT

An exerciser (1) for humans or animals is disclosed. The exerciser comprises a base (2) for mounting on a support surface such as the ground with an electric motor mounted on the base (2). The electric motor is coupled to a direct drive gearbox which in turn is coupled by means of a hollow shaft to a drive shaft. The drive shaft and superstructure mounted on top of it is supported by a vertical support comprising a barrel with taper bearings and a barrel support outward of the barrel. The barrel support and not the barrel is mounted to the base, by welding, so as not to compromise the close tolerance of manufacture of the cylinder. The drive shaft has a vertical axis and extends upwardly to a turntable (3) that is driven to rotate by the drive shaft. A plurality of arms (5) is mounted on the turntable (3) and each extend radially outward there from. The arms (5) are equally angularly spaced from each other and arm extensions (8) are mounted on each arm (5). The arm extensions (8) are telescopically received within the associated arm (5) and locating formations receive the arm extension within the arm by the correct length. Dividers (10) are suspended from each arm extension (8) to divide the exerciser 1 up into different compartments each of which can receive a horse.

### FIELD OF THE INVENTION

This invention relates to an exerciser for humans and/or animals.

This invention relates particularly but not exclusively to an exerciser for horses, eg racehorses, (hereinafter called a horse exerciser) and it will be convenient to hereinafter describe the invention with reference to this example application. Its primary uses are for breaking horses in and teaching them to trot, canter and gallop and also for exercising horses to keep them fit. However it is to be clearly understood that the invention is capable of broader application. For example the invention might equally be applied to training dogs, eg racing greyhounds. Conceivably the invention might also be used for training athletes and it needs to be understood that this is not excluded.

### BACKGROUND TO THE INVENTION

Historically people taught horses to trot, canter and gallop on command, using a length of rope or tether and a whip of sorts. They would get the horse to move in a circular fashion around the trainer with the radius being determined by the length of the rope. However this was very labour intensive and was limited in the sense that one person could only exercise one horse at a time.

Basic horse exercisers for training horses to trot, canter and gallop are known. These have advantages over the manual method described above in that the horse is less labour intensive for a trainer and more than one horse can be trained at one time. The exerciser leads the horse around a defined path. Typically known horse exercisers might comprise a base mounted on the ground with a rotatable turntable mounted on the base. The exerciser further has a plurality of arms that are mounted on the turntable and extending radially outward away there from at spaced intervals. The arms define a swept area in the shape of a circle as they rotate. The exerciser might also include an inner and an outer race for laterally confining the horses on a circular track. They also include dividers suspended from the arms forming horse compartments between each pair of adjacent arms.

While horse exercisers of this general type are known they can be difficult to erect in remote locations. Further assembling the exerciser in remote locations can be very costly because machinery and equipment such as welding equipment is required. This has limited the uptake of exerciser's on farms and particularly remote farms.

It would therefore be advantageous if a way could be devised of making the exerciser simpler to transport and/or easier to assemble at its end point. This would reduce the cost of shipping the exerciser to remote locations. It would also reduce the cost of assembling the exerciser at its end location. Ideally the exerciser would be able to be assembled in a remote location without the need for welding equipment and welding expertise or indeed any other engineering expertise. Ideally it would also be able to be assembled by two people and they would not require any lifting equipment.

It would also be advantageous if the structure of the exerciser could be improved to make it more reliable. For example it would be advantageous if the drive transmission could be simplified.

### SUMMARY OF THE INVENTION

According to one aspect of this invention there is provided an exerciser for use by a human or animal, the exerciser comprising:
a base for mounting on a support surface;
a drive means;
a turn table that is rotatably mounted on the base;
a drive transmission means that is driveably coupled to the turn table and the drive means and that is free of a chain or belt drive;
a plurality of arms mounted on the turn table and extending radially outwardly away there from, the arms being angularly spaced apart from each other around the circumference of the turn table, each said arm having an outer end; and
a plurality of arm extensions, each of which is mounted to an associated arm.

Each said arm extension may have an inner end and an outer end and the inner end of the extension may be mounted to the outer end of the arm.

The drive transmission means may include a drive shaft which is driveably coupled to the turntable and a direct drive gearbox. The gearbox may have an input that is driveably coupled to the drive means and an output that is driveably coupled to the drive shaft that drives the turn table. The direct drive gearbox may have an output shaft that is hollow and the drive shaft may be keyed to the hollow shaft. This couples the drive shaft to the hollow shaft whereby to directly transfer drive from the gearbox to the drive shaft.

In an alternative form drive from the output shaft of the motor is transferred to the drive shaft by a chain and sprocket or by a belt and pulley. That is these contrivances could be used instead of the direct drive gearbox. It is important to understand that this could be accomplished in a number of ways and the invention is not limited to any particular way.

The drive means may comprise an electric motor, eg mounted on the base, and the drive means may also include means for varying the speed of the electric motor on demand through a user interface. The user interface may comprise a control box mounted outside of the arms and arm extensions, and the means for varying the speed of the motor may comprise a potentiometer. The speed of the motor can be adjusted from a speed of 250 rpm to 1600 rpm and the gearbox steps this down to produce a speed of rotation of the turn table of 0.833 to 5.33 rpm.

The base may further include a vertical support for supporting the drive shaft and the turn table in their vertical position. The vertical support may carry the weight of the turntable and components mounted thereon while still permitting the turn table and components mounted thereon to rotate relative to the vertical support.

The vertical support may comprise a cylindrical body that circumferentially surrounds the drive shaft and taper bearings that are interposed between the cylindrical body and the drive shaft at both upper and lower ends of the body.

The vertical support may further include seals at each end of the cylindrical body sealing the body to the rotating drive shaft and also a further seal beneath an upper bearing. The support may also include lubricant such as grease packed into the body to lubricate the bearings.

The vertical support may also include a cylindrical body support surrounding the cylindrical body spaced outwardly therefrom.

The cylindrical body and body support may be rigidly mounted to each other by a barrel mounting plate or flange, eg located at least one end of the barrel. Preferably there are mounting plates at each end of the cylindrical body mounting the body on the body support. The body support may be a rectangular base and each mounting plate may comprise a square to round flange. The body support which is spaced away from the rotating drive shaft is then mounted on another part of the base by welding and the like.

The cylindrical body may be a barrel and the body support may be a barrel support. The base may include a ground engaging support frame for mounting on the ground. The drive means may be mounted on the ground engaging support frame, eg directly beneath the support. The base may also include an upwardly extending support frame extending up from the ground engaging support frame to the vertical support holding it in its vertical position.

The upwardly extending support frame may include support struts extending from the base frame up to the vertical support on each side thereof. The body support may be mounted on upper ends of the struts. There may be at least two said struts on opposed sides of the vertical support.

The drive shaft may have a turntable coupling end and a gearbox coupling end. The drive shaft may include a flange at the turntable end for driveably connecting the drive shaft to the turn table.

The flange may be circular with a plurality of spaced bolt holes defined therein. The bolt holes may extend in a circle of constant radius around the centre of the flange and the bolt holes may be approximately equally spaced apart from each other.

The flange may further include a turn table locating formation for correctly locating the turn table on the flange of the drive shaft. The locating formation may comprise a spigot or projection projecting outwardly proud of the remainder of the flange, eg centrally positioned on the flange.

The gearbox coupling end of the drive shaft may have a drive coupling for driveably coupling it to the output shaft of the direct drive gearbox.

The turntable, which is mounted on an output end or upper end of the drive shaft may comprise a vertically extending post, an upper turntable platform at the upper end of the post and a lower turntable platform at the lower end of the post.

The lower turntable platform may be circular and may be of substantially of the same size as the flange of the drive shaft. It may also have a first set of bolt holes for receiving connecting bolts there through that are complementary to those defined in the flange of the drive shaft. Thus the turn table is keyed to the drive shaft and moves together with the drive shaft.

The lower turntable platform may include a further set of bolt holes, eg radially outward of the first set of bolt holes, for receiving connecting bolts that are also passed through the arms for mounting the arms to the turn table.

The upper turntable platform may have a plurality of upper arm locating formations for locating each of the arms in position so that they are correctly angularly spaced apart from each other. The upper arm locating formations may comprise spacers located at spaced intervals around the circumference of the upper turntable platform with each gap between adjacent spacers locating a solid arm.

The upper turn table platform may include yet further bolt holes defined there through for receiving further connecting bolts that are also passed through the arms, for mounting the arms to the turn table. Thus each arm may be mounted to both the lower platform and the upper platform to provide two vertically spaced points of attachment. This provides a simple yet efficacious mode of attaching the arms to the turn table.

The exerciser may be for use with animals which are horses. The exerciser may be particularly useful for use with race horses.

The exerciser may further include a plurality of dividers, each said divider being mounted to and hanging from an associated arm extension. The exerciser may further include an inner barrier and an outer barrier for laterally confining the circular area swept by the dividers. The inner and outer barriers may be in the form of races or barriers.

Thus each horse is laterally confined by the inner and outer races. The horses are confined by adjacent dividers to their front and rear.

The exerciser may also include a liquid containment means, eg a wading pool, for holding water therein positioned on the ground beneath the area swept by the arms as they rotate.

The liquid containment means which is a wading pool may have an open top and the human or animal, eg horse, will have to wade through the water as they move around in a circle with the exerciser. The liquid containment means may have a height of not more than 1.5 metre and the water may have a depth of not more than 1.5 metre, preferably about 1.1-1.3 m, eg 1.2 m.

The apparatus may also include water treatment means for filtering and cleaning the water. The purpose of the treatment will be to reduce harmful components such as bacteria in the water much like the treatment of water from a swimming pool.

The liquid containment means may be circular when viewed in plan view and sized to be at least the same size as the outer race. Other shapes such as square and rectangular may also be used.

According to another aspect of this invention there is provided an exerciser for use by a human or animal, the exerciser comprising:
a base for mounting on a support surface;
a turn table rotatably mounted on the base;
drive means for driving the turn table to rotate;
a plurality of arms mounted on the turn table and extending radially outwardly away there from, the arms being angularly spaced apart from each other around the circumference of the turn table;
a plurality of arm extensions, each of which is mounted to a said arm, the end of one of the arms and the arm extensions being telescopically received within an open end of the other of the arms and arm extensions; and
radial position locating means on one of the arms and arm extensions for receiving the arms or arm extension as the case may be to the correct extent.

The inner ends of said arm extensions may be received within the open outer ends of the associated arms, and said radial position locating means may be positioned on the arm extensions.

Each arm extension may comprise a substantially linear member that is sized to be received within the open outer end of the arm. Each arm extension because it is received within the end of the arm it does not need to be hollow like the arm.

The radial position locating means on each arm extension may comprise a tab projecting laterally outwardly from at least one side of the member at the appropriate point along the linear length of the member. Preferably there are two tabs projecting outwardly from opposed sides. The projections may be sized such that they cannot be received within the open outer end of the arm and this limits the extent to which the arm extension can be telescopically received within the arm. Further the projections may be angled slightly rearwardly, eg away from the free end of the arm extensions.

Each arm may comprise a horizontally extending upper element, a vertical element, and a diagonal hypotenuse element, and also a plurality of stiffening braces or struts or arms extending between the horizontal member and the upper element. These support the arm as a structure in itself.

The upper member of each arm may be made of hollow tube, eg square or round steel tube, and have a said open outer end through which the end of the arm extension is passed.

Each arm may further include mounting formations at each of the top and bottom of the vertical element for mounting the arm to the turn table. Each mounting formation may be in the form of a boss or flat plate, that is horizontally extending for resting on a horizontal surface of the turntable, with a bolt aperture defined therein, whereby to enable each arm to be mounted on the turntable by passing a bolt through the bolt aperture and a corresponding bolt aperture on the turntable.

The plate at the top of the vertical element may be mounted to the upper platform of the turn table. Correspondingly the plate at the bottom of the vertical element may be mounted to the lower platform on the turn table, eg at a point radially outward of the attachment of the mounting flange to the drive shaft.

The exerciser may further include a plurality of dividers, eg in the form of a sheet, each divider being supported from an associated arm extension. Typically there is a divider associated with each arm extension.

The arm extensions may further include means for suspending the dividers there from. The means for suspending the dividers there from may comprise at least two tabs longitudinally spaced along the length of the arm extension outward of said tab forming said radial position locating means. The spaced plates or tabs have openings or apertures defined therein.

Each divider may have mounting pins projecting sideways out of each side of the sheet towards an upper end thereof, eg which are received in the openings in the tabs forming the suspending means. Thus the divider may be hung or suspended from the arm extension. The divider sheet may comprise an upper mesh portion and a lower belt portion.

The exerciser may further include means for holding the arms the correct distance apart from each other and the holding means may comprise a plurality of stabiliser rods. Each said rod may extend between adjacent arms and/or arm extensions towards the radially outer ends of the arm whereby to angularly position the arms relative to each other around the turn table such that they extend outwardly in the correct radial position. The stabiliser rods perform the important function of angularly positioning the arms relative to each other such that they define equal sized compartments.

The exerciser may also include means for resisting movement of the arm extension out of the open end of the arm.

The means for holding the arm extensions on the associated arm may comprise said arm stabiliser rods which are attached to the arm extensions, eg the radial position locating means thereof, to pull them onto the arms.

Each arm extension may include at least one stabiliser rod attachment formation thereon for attaching the stabiliser rod there to. Preferably each said arm extension has two said attachment formations, one on each side thereof. One said attachment formation is for the stabiliser rod extending towards the adjacent arm extension in a clockwise direction. The other extends to the adjacent arm extension in an anti clockwise direction.

Conveniently the stabiliser rod attachment formations may be provided by the tabs on the arm extensions forming the locating means that limit the travel of the arm extensions into the open end of the arms. In the preferred forms there are two said tabs on each arm extension one on each side and they also form the attachment formations for the stabiliser rods extending out from each side of the arm extensions. Thus the arm stabiliser rods may utilise an already existing formation that is on the arm extension.

According to another aspect of this invention there is provided an exerciser for use by a human or animal, the exerciser comprising:
a base for mounting on a support surface, the base including a surface engaging support frame and a vertical support mounted on said support frame, the vertical support comprising a barrel support and a barrel mounted on said barrel support spaced radially outward of the barrel, and means for mounting the barrel support to the barrel;
a drive shaft rotatably received within the barrel;
a turn table rotatably mounted on the drive shaft;
drive means for driving the drive shaft to rotate;
a plurality of arms each of which is mounted on the turn table and extends radially outwardly away there from, the arms being angularly spaced apart from each other around the circumference of the turn table; and
a plurality of dividers each of which is associated with a said arm for dividing up the area swept by the arms into a number of horse compartments.

The means for mounting the barrel to the barrel support may be attached to the barrel towards one or more ends of the barrel and not intermediate the ends of the barrel.

The means for attaching the barrel support to the barrel may comprise at least one transverse plate extending between the barrel and the barrel support. Preferably the attaching means comprise transverse plates or flanges towards each of opposing ends of the barrel and barrel support. In a most preferred form there is a square to circular flange extending between the upper ends of the barrel and barrel support and a corresponding further square to circular flange extending between the lower ends of the barrel and barrel support. These flanges that are welded to the barrel and barrel support then provide the necessary rigidity and strength in the mounting of the barrel to the barrel support.

Thus the remainder of the base is welded to the barrel support which is something different from the barrel and is spaced away there from. When the base frame is welded to the barrel support any deformation that occurs as a result of the welding process is imparted to the barrel support and not the barrel which is not distorted or deformed in any way. This is important to maintain the fine tolerance and the friction free rotation of the drive shaft within the barrel.

The base may include arms extending up to the barrel support and the barrel support may be welded to these arms.

The exerciser described in this aspect of the invention may include any one or more of the preferred or optional features described above with respect to the first aspect of the invention.

This invention also extends to a method of training a horse using an exerciser in accordance with any one of the first or second aspects of the invention described above.

Further the invention also extends to a method of manufacturing and then assembling the horse exerciser described above according to the first or second aspect of the invention.

The method may include using jigs for the manufacture of each of the arms and the arm extensions such that they are made to fine tolerances such that any arm can be mounted on any radial position of the turn table and the outer ends of the arms are all positioned at the same height.

### DETAILED DESCRIPTION OF THE INVENTION

A horse exerciser in accordance with this invention may manifest itself in a variety of forms. It will be convenient to hereinafter describe in detail at least two preferred embodiments of the invention with reference to the accompanying drawings. The purpose of providing this detailed description is to instruct persons having an interest in the subject matter of the invention how to carry the invention into practical effect. It is to be clearly understood however that the specific nature of this detailed description does not supersede the generality of the preceding board description. In the drawings:

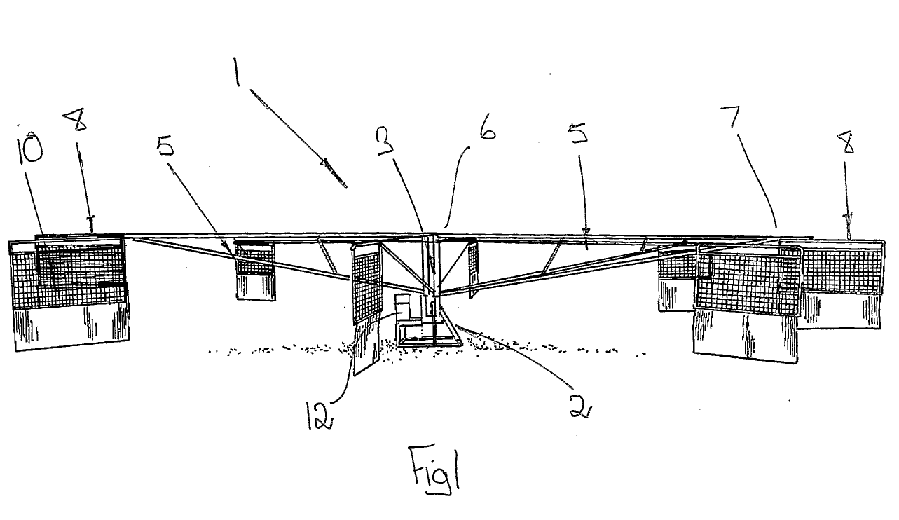

FIG. 1 is a three dimensional view of a horse exerciser in accordance with one embodiment of the invention;

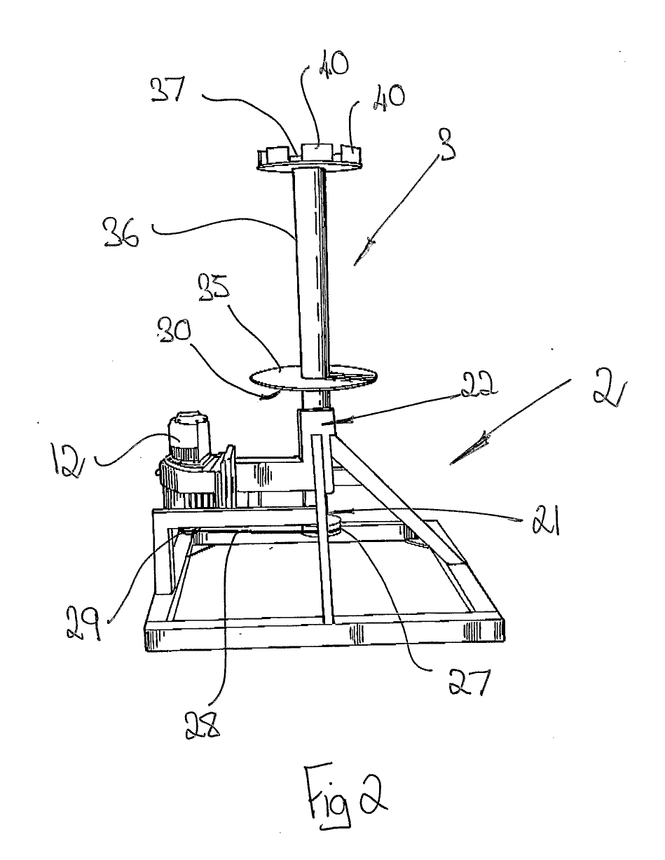

FIG. 2 is a three dimensional view of a base, a drive and a drive transmission for the horse exerciser of FIG. 1;

FIG. 3 is a cross-sectional front view of a part of the horse exerciser of FIG. 1 showing a barrel and barrel support;

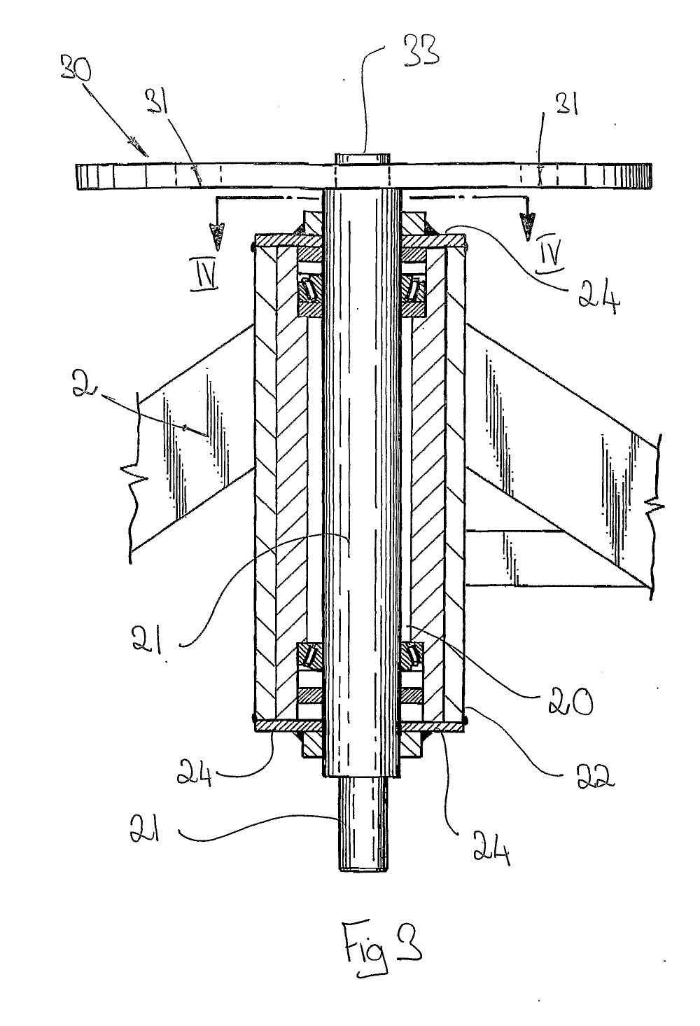

FIG. 4 is a part sectional top view of the barrel and barrel support of FIG. 3, Section through IV-IV;

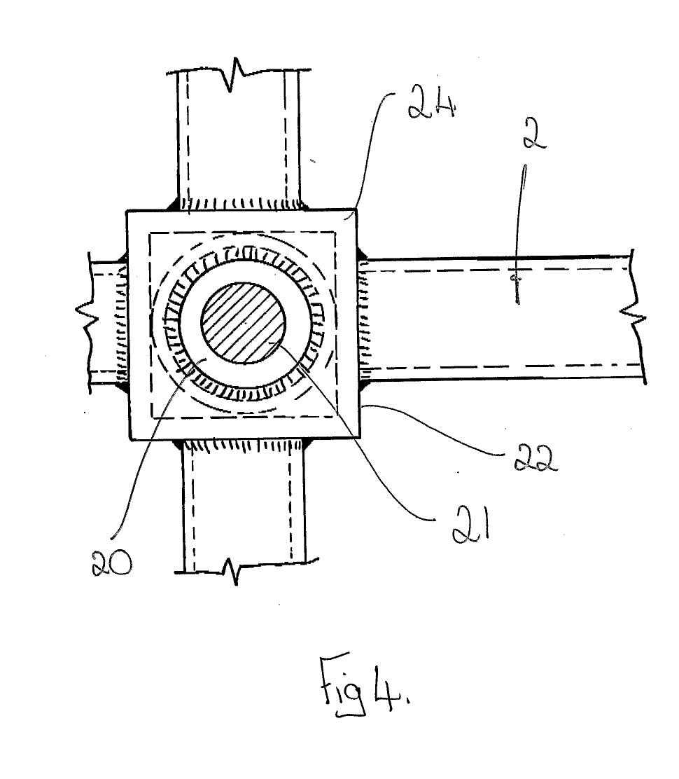

FIG. 5 is a three dimensional view of a turn table of the horse exerciser of FIG. 1 showing how an arm is attached there to;

FIG. 6 is a schematic top plan view of the horse exerciser of FIG. 1 showing the arms, arm extensions and turntable but with some detail omitted for clarity;

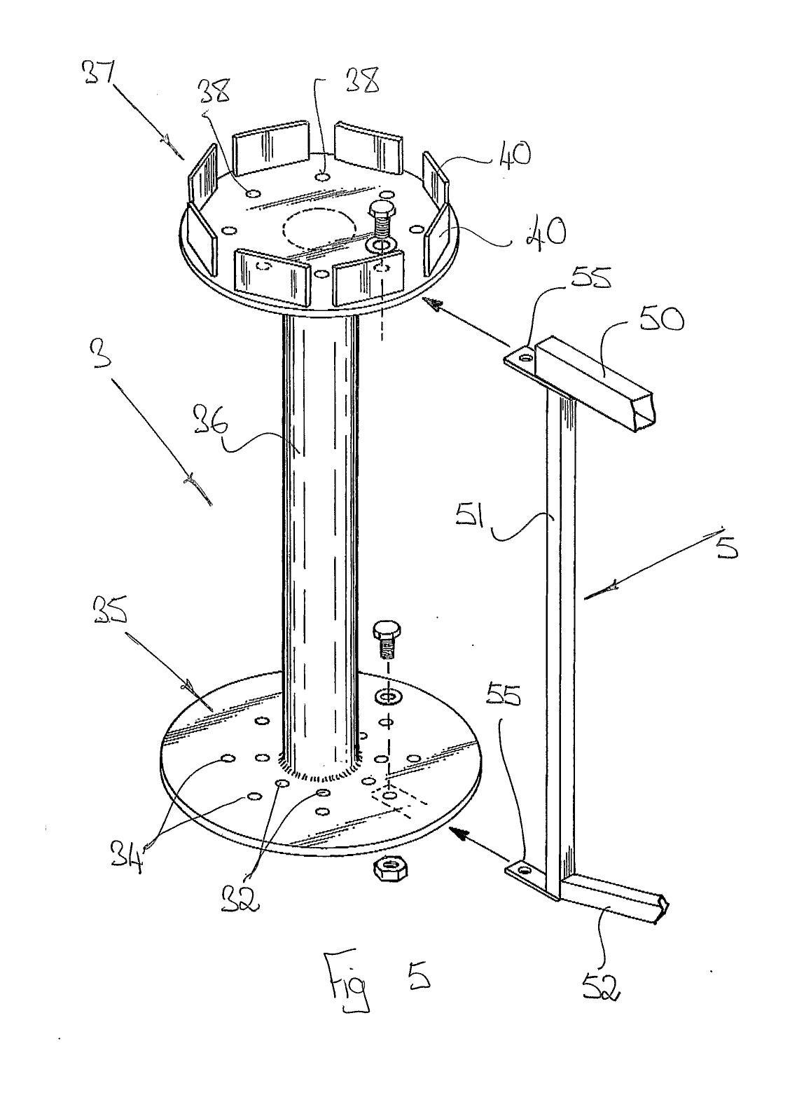

FIG. 7 is a front view of an arm of the exerciser of FIG. 1;

FIG. 8 is a three dimensional view showing an upper region of an inner end of the arm with an upper mounting formation;

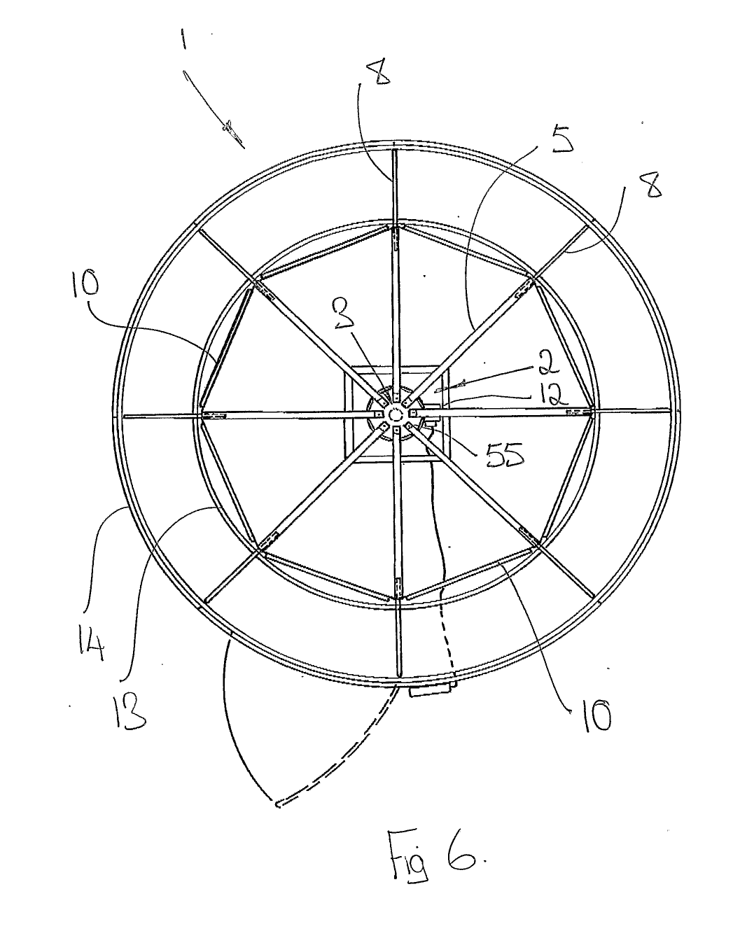

FIG. 9 is a three dimensional view showing a lower region of an inner end of the arm with a lower mounting formation;

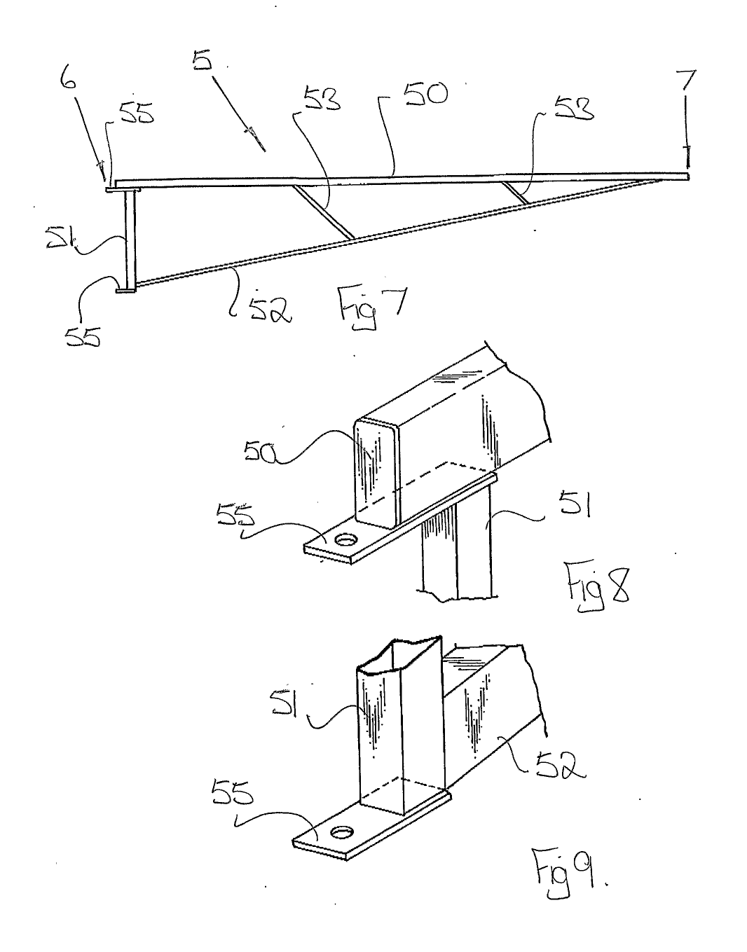

FIG. 10 is a bottom plan view of an arm extension for mounting on the arm of the horse exerciser of FIG. 1;

FIG. 11 is a front view of the arm extension of FIG. 10 for mounting on the arm of the horse exerciser of FIG. 1;

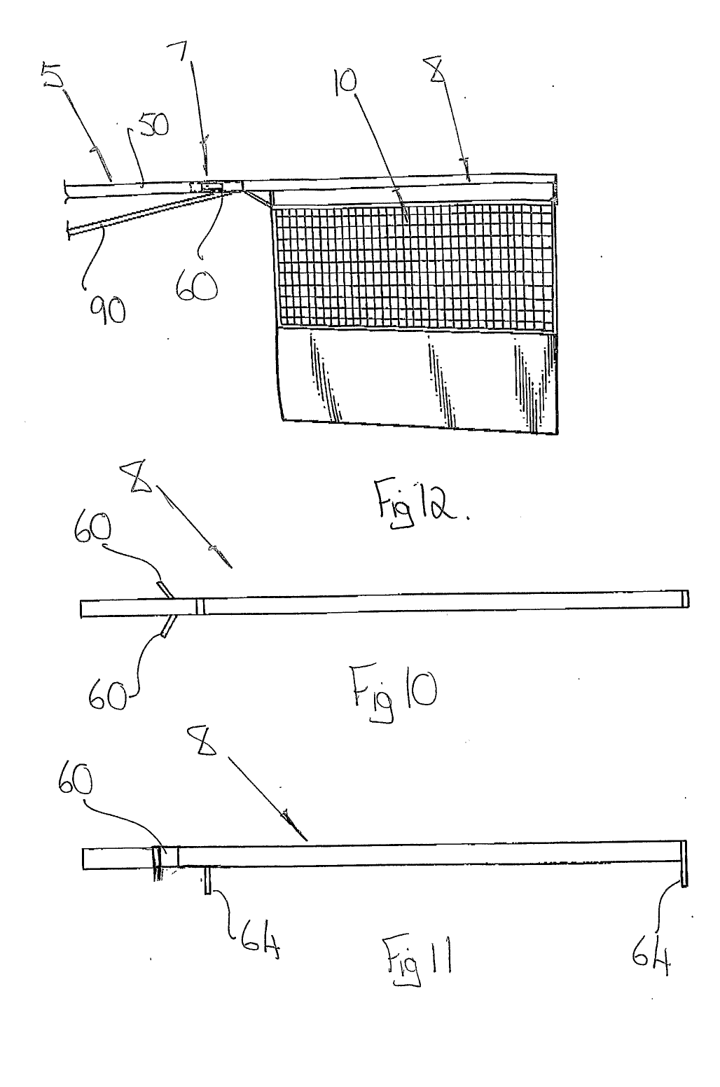

FIG. 12 is a front view of the arm extension of FIG. 10 mounted on the arm of the exerciser of FIG. 1 and showing a divider suspended from the arm extension;

FIG. 13 is a front view of a divider;

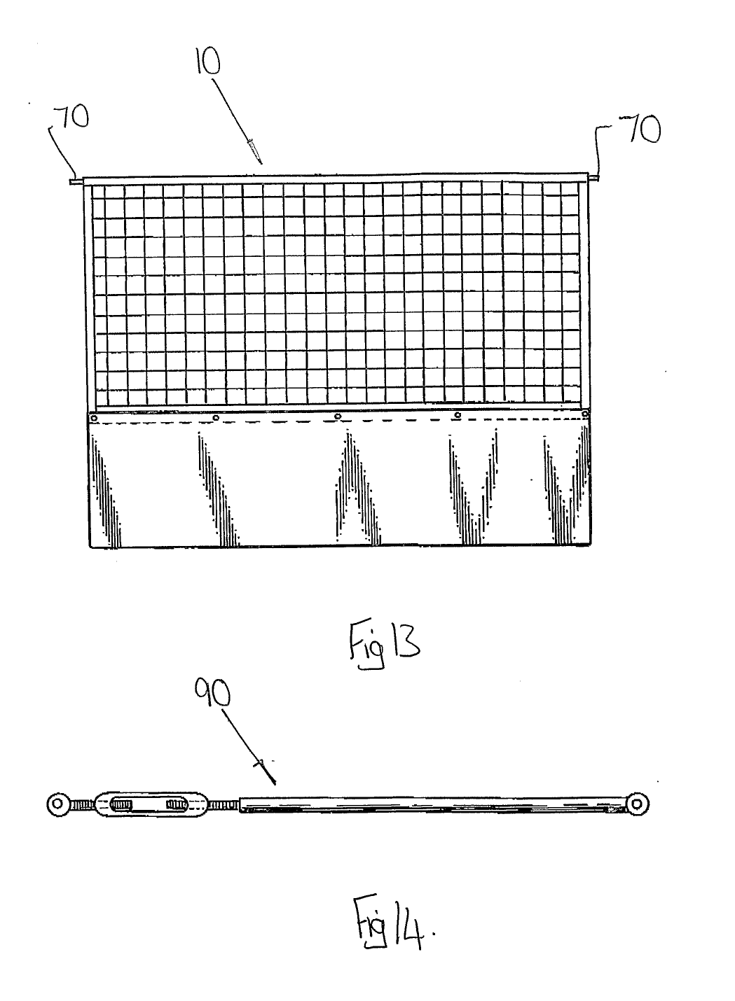

FIG. 14 is a front view of an arm stabiliser rod for stabilising the radial position of the exerciser of FIG. 1;

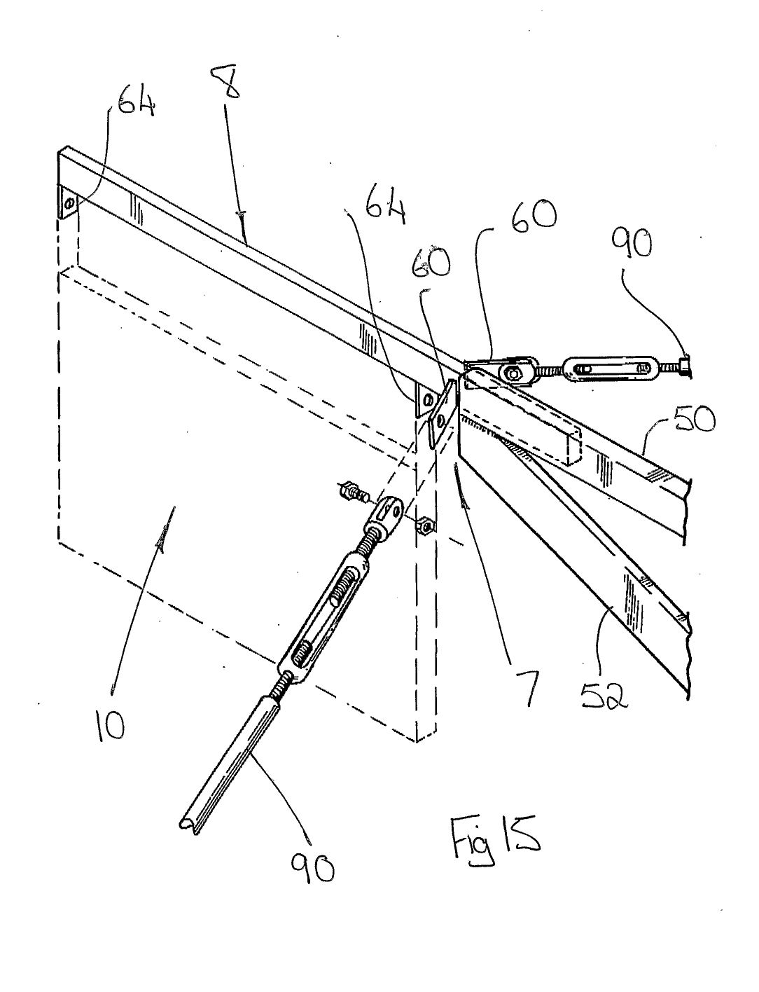

FIG. 15 is a three dimensional view showing detail of the telescopic attachment of the arm extension to the arm and also the attachment of the stabiliser rods thereto; and

FIG. 16 is a three dimensional view of a base, a drive and a drive transmission for a horse exerciser in accordance with a second embodiment.

In FIG. 1 reference numeral 1 refers to a horse exerciser in accordance with the invention.

The horse exerciser 1 comprises broadly a base 2 which is mounted on a support surface such as the ground. A rotatable turn table 3 is rotatably mounted on the base 2.

A plurality of arms 5 are mounted on the turn table 3 extending radially outwardly away from the turn table 3. The arms 5 have inner and outer ends 6 and 7 and are angularly spaced apart from each other at equal intervals. The outer end 7 of each arm 5 is open and an arm extension 8 is telescopically received within the outer end 7 of the associated arm 5.

The exerciser 1 also includes radially inner and outer barriers 13 and 14 that define a circular path that is traveled by the horses during exercise. These are often referred to as the inner and outer races. As the structure of the races would be well known to persons skilled in the art and also to keep the drawings as simple and clear as possible the races have not been shown in all the drawings.

A divider 10 is mounted on each arm extension 7 and extends downwardly there from to divide the circular area swept by the arms 5 into different horse compartments.

The exerciser 1 also includes a drive means in the form of an electric motor 12 that is mounted on the base 2 and also includes a drive transmission means for driveably coupling the drive means to the turn table 3 for driving the turn table 3 to rotate.

The motor that is used is an AC motor. A domestic mains supply of single phase electricity is passed through an inverter which converts it to three phase which is then used to energise the motor. The motor typically draws less then 2 Amp of current when it is at speed.

A control box is operatively associated with the motor. Typically this is positioned outside of the arm extensions for ease of access. A potentiometer (not shown) in the control box enables the voltage that is supplied to the coil of the motor to be varied which in turn varies the speed of the motor and the rpm of the turntable. The motor may have a speed of 200-1900 rpm. As AC motors, inverters and potentiometers will be well known to persons skilled in the art they will not be described further in the specification.

We now turn to discuss each of the components in greater detail.

As shown in FIG. 2 the base 2 comprises a ground engaging support frame that is a rectangular open frame resting on the ground with an upwardly extending frame extending upwardly there from. The upwardly extending frame has three struts or arms that extend up at an angle and carry the main weight of the superstructure. The open frame also includes a mounting bracket on which the electric motor 12 is mounted for driving the turn table 3 to rotate.

As shown in FIGS. 3 and 4, the base 2 also includes a vertical support including a cylindrical body which is a barrel 20 and has a vertically extending orientation. A drive shaft 21 is rotatably received within the barrel 20. The vertical support also includes a barrel support 22 which surrounds the barrel 20 radially outwardly of the barrel 20. The barrel 20 is mounted to the barrel support 22 by square to round flanges 24 that are welded to the top and bottom of both the barrel 20 and barrel support 22. The barrel support 22 is then mounted to the remainder of the base 2.

By avoiding welding the frame 15 directly to the barrel 20, distortion of the barrel 20 as a result of the welding is resisted. This enables the drive shaft 21 to be received within the barrel 20 yet still rotate freely in the barrel 20 without interference. It preserves the fine tolerance circular cross sectional configuration of the barrel 20.

As shown in FIG. 3, the drive shaft 21 comprises a circular cylindrical member that projects out the top and the bottom of the barrel 20. The drive shaft 21 is vertically supported in position by bearings, eg taper or roller bearings, at the top and the bottom of the barrel as shown in FIG. 3. The barrel 20 also has seals for sealing the barrel 20 against the rotating shaft 21. A lubricant which is grease is enclosed within the barrel 20 to lubricate the bearings.

As shown in FIG. 2, the lower end of the drive shaft 21 projects out of the bottom of the barrel 20 and has a pulley 27 mounted thereto. The motor 12 has an output shaft with a pulley 29 mounted thereto.

A belt 28 is mounted on the pulley 27 of the drive shaft 21 and also the further pulley 29 on the motor 12 to connect the electric motor 12 to the drive shaft 21 received within the barrel 20. This way drive from the motor 12 is transmitted to the drive shaft 21 in the barrel 12.

It should be understood that the belt drive shown in the drawings is just one way of transferring drive from the motor across to the drive shaft. For example a sprocket and chain could equally be used. Applicant has also used a hollow shaft gearbox and has found this to be particularly convenient and efficacious. This is described below with reference to FIG. 16.

As shown in FIG. 3, a circular flange 30 is mounted on top of the drive shaft 21. The flange 30 has a plurality of holes 31 therein for mounting the drive shaft 21 to the turn table 3 as will be described in more detail below.

The flange 30 also includes a spigot 33 on the upwardly facing surface of the flange 30, that is remote from the flange. The spigot 33 is located centrally for correctly positioning the turn table 3 on the flange 30 when the turn table 3 is mounted on the flange 30.

As shown in FIG. 5, the turn table 3 comprises a lower platform that is a circular plate member or flange 35 mounted on the upper surface of the flange 30, a short central upright member 36 and then an upper platform 37 that is also a circular flange.

The flange 30 is mounted to the lower platform 35 by means of a face to face attachment or flange to flange attachment of flange 30 and lower platform 35. Bolts are passed through a plurality of aligned bolt holes 32 in said flanges 30, 35.

The lower platform 35 also has a second set of holes defined therein 34 (not shown in all drawings) for mounting a lower region of each arm 5 thereto. These holes 34 are generally positioned radially outward of the holes 32 used for attachment of the flange 30 thereto.

The upper turn table platform 37 has a plurality of holes 38 defined therein for mounting the arms 5 thereto in a similar fashion to that achieved on the lower platform 35. A plurality of upstanding spacers 40 are also located around the circumference of the turntable 3 with spaces defined between them to receive and position the arms 5 as will be described in more detail below.

The spacers 40 each comprise a plurality of linearly extending steel rods or plates of approximately half inch thickness with adjacent ends of the rods being spaced apart from each other to receive an arm 5 there between.

The structure of each arm 5 is shown in FIGS. 7 to 9.

Each arm 5 comprises a horizontal extending upper member 50, an upright member 51, and a diagonal or hypotenuse member 52 extending between the lower end of the upright member 51 and the radially outer end 7 of the upper member 50. A plurality of struts or cross braces 53 extend between the diagonal and upper members to brace and stiffen the arms 5. Further the arm 5 has attachment formations or flats or bosses 55 at both the top and bottom of the vertically extending member 51 and these are used to mount the arm 5 to the turn table 3.

Typically each arm 5 may be fabricated out of standard sections of steel with the different members being welded together. Each arm 5 is mounted to the turn table as follows. Firstly the arm 5 is correctly radially positioned by passing the upper member 50 through the space between adjacent spacers 40 on the turn table 5. The attachment formations or flats 55 at each of the top and bottom of the vertically extending member 51 are mounted to respectively the element 35 and the upper element 37 by passing bolts through aligned apertures in each of the flats 55 and the relevant component of the turn table 3.

Another important feature of the arm 5 is that the outer end 7 of the upper member 50 is open. This open end 7 receives the end of the arm extension 8 as will be described in more detail below.

The arm extension 8 is shown in FIGS. 10 to 12. It comprises an elongate linear member, eg a square rod, square tube or the like. The member is sized such that it can be received within the open end of the arm 5 with at least a small amount of clearance.

The member 8 has radial position locating formations or stop formations 60 projecting laterally outwardly away from both sides of the member 8 for receiving the extension 8 within the arm 5 the correct distance. In the illustrated form the stop formations 60 are in the form of tabs or bosses that project out from each side of the member 8.

The arm extension member 8 also has mounting formations 64, longitudinally spaced apart from each other, for mounting the divider 10 thereto. The mounting formations 64 may be in the form of brackets or tabs 64 that project down from the arm extension member 8. The mounting formations 64 also have apertures for fixing a divider 10 thereto.

When the arm extension member 8 is mounted to its associated arm 5, the inner end proximate to the stop formation 60 is passed into the open end 7 of the upper member of the arm 5 in a telescoping fashion until the locating formations 60 abut the end 7 of the upper member 50. The locating formations 60 thus prevent the arm extension 8 from being received further within the member 50. This is shown in FIG. 18.

As shown in FIG. 13, each divider 10 comprises basically a planar panel that provides a barrier to horse movement through there by confining a horse to the area between two adjacent dividers 10. Each divider 10 has mounting pins 70 projecting laterally outwardly from each end there of for mounting the divider to the associated arm extension 8. Each divider 10 is suspended from its associated arm extension 10 by passing the mounting pins or the like 70 through the apertures defined in the mounting formations 64 as shown in the drawings.

The horse exerciser 1 also includes means for holding the arm extensions 8 in position and also holding the outer ends of the arms 5 in the correct radial position. The extension holding means and arm positioning means comprises arm stabiliser rods 90 extending between adjacent arms 5 and particularly the locating formations 60 on the arm extensions 7 as shown in FIG. 14. Specifically they can be passed through holes in the locating formations 60. These rods 90 hold each arm extension 8 onto its associated arm 5. They also hold the end of each arm 5 in its correct radial position spaced the appropriate distance from both adjacent arms 5. Each rod 90 may include a turnbuckle for tensioning it appropriately when it is fitted. A plan view of an assembled exerciser showing many of the components described above is shown in FIG. 6.

In use the exerciser 1 is shipped from its site of manufacture to the farm where it is going to be used. This might be accomplished by road freight. The exerciser is shipped as a disassembled load of components to form as compact a load for road transport.

Once it arrives at the location where it will be used the exerciser 1 has to be assembled. Firstly the drive system including drive transmission and then the turntable 3 is mounted on the base 2 to produce the sub-structure shown in FIGS. 2 and 16. The arms 5 are then mounted on the turntable 3 as described above. There after the arm extensions 8 are mounted in turn on each arm 5 and then the arm stabilising rods 90 are connected up to the locating formations 60 of adjacent arm extensions 8. Finally the dividers 10 are hung from the arm extensions 8 of each arm 5. The assembly of the exerciser 1 requires some manual strength to lift the various components such as the arms 5 and the arm extensions 8 into position. However it does not require mechanical lifting equipment. Further the various components are simply bolted together using basic farm yard tools and it does not require welding equipment. The assembled exerciser is shown in FIG. 6.

The exerciser is used to train horses. One or more horses are placed in the space between adjacent dividers 10 and the inner and outer races which defines a horse compartment. The motor is then started causing the shaft 21 and the turntable 3 to rotate. This is turn causes the arms 5 to rotate with associated dividers 10. This requires each horse to move within its compartment and to keep pace with the rotation of the arms. The speed of rotation of the arms can be varied by the motor. The exerciser can be useful for training horses and for exercising horses to keep them fit particularly race horses.

After the exercise period has finished the motor is switched off causing the rotation of the arms to slow. Each horse slows with the arms until they stop and they can then be led out of the exerciser.

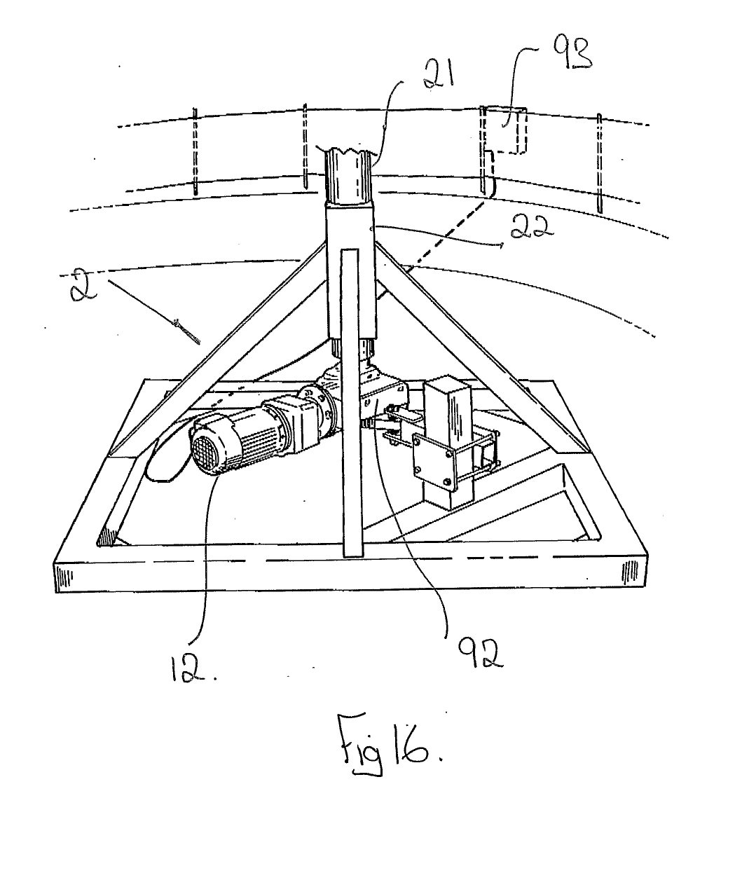

In FIG. 17 a drive means and drive transmission means in accordance with a second embodiment of the invention is shown.

The electric motor 12 is directly coupled to a direct drive gearbox 92 which has a hollow output shaft. The lower end of the drive shaft 21 is received within the hollow shaft and is driveably keyed there to. The motor 12 is an AC motor with a potentiator for adjusting the speed of the motor from 250 rpm to 1600 rpm. This translates into a speed of rotation of the turntable from 0.833 to 5.33 rpm. A user is able to control the speed by means of a user interface in the form of a control box 93 that may conveniently be mounted outside of the arm extensions. The direct drive gear box can be purchased off the shelf as can the motor. As these components on their own do not form part of the invention and their structure and function would be well known to persons skilled in the art they will not be described in more detail in the specification.

In use the direct drive transfers drive efficiently to the drive shaft. Further the direct drive is very reliable and requires little or no maintenance.

An advantage of the horse exerciser described above with reference to the drawings is that it can be manufactured and shipped as a plurality of components and then be assembled fairly easily at its end point where it is to be used. It is assembled by bolting different components together and does not require any welding to be carried out at the assembly stage. This is important because the exercisers are often used on farms in remote locations far from fabrication facilities and far from the site of manufacture. Specifically the components are bolted together and do not need to be welded together.

The cylindrical body which receives the drive shaft and vertically supports the superstructure of turntable, arms and arm extensions is surrounded by a body support that is welded to the base. The fact that the outer barrel support rather than the barrel is welded to the base preserves the finely toleranced symmetry of the cylindrical body for smooth and low friction rotation of the drive shaft within the body. Further the direct drive gearbox provides an efficient and reliable transfer of drive from the motor directly to the drive shaft. This is superior to a drive incorporating a belt or chain.

The exerciser described and illustrated above is strong and reliable in operation. It is a robust piece of engineering that requires only very low maintenance.

It will of course be realised that the above has been given only by way of illustrative example of the invention and that all such modifications and variations thereto as would be apparent to persons skilled in the art are deemed to fall within the broad scope and ambit of the invention as herein set forth.

1. An exerciser for use by a human or animal, the exerciser comprising:
a base for mounting on a support surface;
a drive means;
a turntable that is rotatably mounted on the base;
a drive transmission means including a shaft that is driveably coupled to the turntable and a direct drive gearbox having an input that is driveably coupled to the drive means and an output that is directly coupled to the drive shaft that drives the turntable;
a plurality of arms mounted on the turntable and extending radially outward there from, the arms being angularly spaced apart from each other around the circumference of the turntable, each said arm having an outer end; and
a plurality of arm extensions, each of which is mounted to an associated arm.

2. The exerciser according to claim 1, wherein the direct drive gearbox has an output shaft that is hollow and the drive shaft is received within the hollow shaft and keyed thereto whereby to directly transfer drive from the gearbox to the drive shaft.

3. The exerciser according to claim 2, wherein the drive means comprises an electric motor and means for varying the speed of the electric motor on demand through a user interface.

4. The exerciser according to claim 3, wherein the user interface comprises a control box mounted on the base and the means for varying the speed of the motor comprises a potentiometer, wherein the speed of the motor can be adjusted from a speed of 250 rpm to 1600 rpm and the gearbox steps this down to produce a speed of rotation of the turntable of 0.833 to 5.33 rpm.

5. The exerciser according to claim 1, wherein the base includes a vertical support that supports the drive shaft and turntable in their vertical position such that the weight of the turntable and components mounted thereon rests on the vertical support while still permitting the turntable and components mounted thereon to rotate relative to the vertical support.

6. The exerciser according to claim 5, wherein the vertical support comprises a cylindrical body that circumferentially surrounds the drive shaft and taper bearings are interposed between the cylindrical body and the drive shaft at both upper and lower ends of the body, and a body support surrounding the cylindrical body spaced outwardly from said cylindrical body.

7. The exerciser according to claim 6, wherein the vertical support includes seals towards each end of the cylindrical body sealing the body to the rotating drive shaft and further including lubricant packed into the body to lubricate the bearings.

8. The exerciser according to claim 7, wherein the base further includes a surface engaging support frame for mounting on a ground or floor surface, the drive means being mounted on the ground engaging support frame, and an upwardly extending support frame extending up from the surface engaging support frame supporting the vertical support in its vertical position.

9. The exerciser according to claim 8, wherein the upwardly extending support frame includes support struts extending from the base frame up to the vertical support on at least two opposed sides thereof to support the body in its vertical position.

10. The exerciser according to claim 1, wherein the turntable comprises a vertically extending post, an upper turntable platform at the upper end of the post and a lower turntable platform at the lower end of the post.

11. The exerciser according to claim 10, wherein the upper turntable platform has upper arm locating formations for locating each of the arms in a desired position angularly spaced apart from each other.

12. An exerciser according to claim 11, wherein the upper arm locating formations comprise spacers located at spaced intervals around the circumference of the upper turntable platform.

13. An exerciser according to claim 12, wherein the upper and lower turntable platforms have apertures facilitating the attachment of the arms to respective platforms by means of fasteners passed through the apertures.

14. An exerciser for use by a human or animal, the exerciser comprising:
a base for mounting on a support surface;
a turntable rotatably mounted on the base;
drive means for driving the turntable to rotate;
a drive transmission means including a drive shaft which is driveably coupled to the turntable and a direct drive gearbox having an input that is driveably coupled to the drive means and an output that is driveably coupled to the drive shaft that drives the turntable;
said direct drive gearbox having an output shaft that is hollow whereby the drive shaft is received within the hollow shaft and keyed thereto in order to directly transfer drive from the gearbox to the drive shaft;
a plurality of arms mounted on the turntable and extending radially outward therefrom, the arms being angularly spaced apart from each other around the circumference of the turntable;
a plurality of arm extensions, each of which extensions is mounted to a respective arm, wherein the mounting means includes telescopically engaging end portions; and
radial position locating means associated with the arms and arm extensions for locating the arm extensions at desired radial positions.

15. The exerciser according to claim 14, wherein inner ends of said arm extensions are received within the open outer ends of respective arms, and said locating means are positioned on the arm extensions.

16. The exerciser according to claim 15, wherein each arm comprises a horizontally extending upper member, a vertical member, and a diagonal hypotenuse member, and wherein a plurality of stiffening braces extends between the horizontal upper member and the diagonal hypotenuse member.

17. The exerciser according to claim 16, wherein the upper member of each arm comprises a hollow tube with said end portion thereof including an open outer end within which the arm extension is received.

18. The exerciser according to claim 16, wherein each arm further includes mounting formations at each of the top and bottom of the vertical element for mounting the arm to the turntable.

19. The exerciser according to claim 18, wherein each mounting formation includes a flat plate that, in use, extends substantially horizontally for resting on a cooperating surface of the turntable, said flat plate having an aperture provided therein allowing each arm to be mounted on the turntable by passing a fastener through the aperture in the flat plate and a corresponding aperture in the turntable.

20. The exerciser according to claim 19, wherein each arm extension comprises a substantially linear rod or tubular member sized to be received within the open outer end of the arm.

21. The exerciser according to claim 20, wherein the radial position locating means on each arm extension comprises a tab that projects out from the arm extension at an appropriate point along its length and which cannot be received within the arm.

22. The exerciser according to claim 15, further including means for holding the arms a desired distance apart from each other and for resisting movement of the arm extension out of the open end of the arm.

23. The exerciser according to claim 22, wherein the holding means comprises a plurality of stabiliser rods, each said rod extending between adjacent arms and/or arm extensions towards the radially outer ends of the arm whereby to angularly position the arms relative to each other around the turntable such that they extend outwardly in a desired radial position.

24. The exerciser according to claim 23, wherein each said stabiliser rod has one end mounted on a said arm extension and an opposed end mounted on an adjacent said arm extension.

25. The exerciser according to claim 24, wherein each said arm extension has two said tabs, one each on opposed sides thereof, and each said stabiliser rod is mounted on said tabs.

26. The exerciser according to claim 25, wherein the arm extensions further include means for suspending dividers therefrom.

27. An exerciser according to claim 26, wherein said means for suspending the dividers there from comprises at least two tabs longitudinally spaced along the length of the arm extension outward of said tab forming said locating means.

28. An exerciser for use by a human or animal, the exerciser comprising:
a base for mounting on a support surface, the base including a surface engaging support frame and a vertical support mounted on said support frame, the vertical support comprising a barrel support and a barrel mounted on said barrel support spaced radially outward of the barrel, and means for mounting the barrel support to the barrel;
a drive shaft rotatably received within the barrel;
a turntable rotatably mounted on the drive shaft;
drive means for driving the drive shaft to rotate via a direct drive gearbox having an input that is driveably coupled to the drive means and an output that is directly coupled to said drive shaft;
a plurality of arms each of which is mounted on the turntable and extends radially outward therefrom, the arms being angularly spaced apart from each other around the circumference of the turntable; and
a plurality of dividers each of which is associated with a said arm for dividing up the area swept by the arms into a number of horse compartments.

29. A turntable drive sub-assembly for driving an exerciser for use by a human or animal, the drive sub-assembly comprising:
a base for mounting on a support surface;
a turntable that is rotatably mounted on the base;
a drive means for rotating the turntable; and
a drive transmission means including a shaft that is driveably coupled to the turntable and a direct drive gearbox having an input that is driveably coupled to the drive means and an output that is directly coupled to the drive shaft that drives the turntable.

30. The turntable drive sub-assembly of claim 29 wherein the direct drive gearbox has an output shaft that is hollow and the drive shaft is received within the hollow shaft and keyed thereto, whereby to directly transfer drive from the gearbox to the drive shaft.
